(19) United States
(12) Patent Application Publication
(10) Pub. No.: US 2006/0126491 A1
(43) Pub. Date: Jun. 15, 2006

(54) Cell search apparatus and method in a mobile communication system using multiple access scheme

(75) Inventors: Jung-Min Ro, Seoul (KR); Young-Kwon Cho, Suwon-si (KR); Sung-Kwon Hong, Seoul (KR); Su-Ryong Jeong, Suwon-si (KR); Young-Kyun Kim, Sungnam-si (KR); Dong-Seek Park, Yongin-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/231,255

(22) Filed: Sep. 20, 2005

(30) Foreign Application Priority Data
Sep. 20, 2004 (KR) 2004-0074999

(51) Int. Cl. H04J 11/00

(52) U.S. Cl. 370/208

(57) ABSTRACT

A cell search apparatus and method in an OFDM mobile communication system are provided. In the cell search apparatus, a symbol synchronization acquirer acquires OFDM symbol synchronization by performing CP correlation for a plurality of OFDM symbol intervals. A frame cell synchronization acquirer sorts received OFDM symbols according to the acquired OFDM symbol synchronization, and acquires frame cell synchronization by performing preamble correlation for a plurality of frame cell intervals. A pilot pattern detector sorts received frame cells according to the acquired frame cell synchronization, and detects a pilot pattern for identifying a base station by monitoring a plurality of frame cells.

### PRIORITY

This application claims priority under 35 U.S.C. §119 to an application entitled “Cell Search Apparatus And Method In A Mobile Communication System Using Multiple Access Scheme” filed in the Korean Intellectual Property Office on Sep. 20, 2004 and assigned Serial No. 2004-74999, the contents of which are incorporated herein by reference.

### BACKGROUND OF THE INVENTION

1. Field of the Invention

The present invention relates generally to a mobile communication system using a multiple access scheme, and in particular, to a cell search apparatus and method in an Orthogonal Frequency Division Multiple Access (OFDMA) mobile communication system.

2. Description of the Related Art

Upon power-on, a mobile station (MS) typically performs an initial cell search by acquiring pseudo noise (PN) code timing in a Code Division Multiple Access (CDMA) mobile communication system, for example, an IS-95 system. A base station (BS) transmits on a forward pilot channel a PN code to all of the MSs within its coverage area. The forward pilot channel is an unmodulated sequence spread with the PN code. The MS carries out synchronization acquisition, channel estimation, and BS identification using the pilot channel.

Regarding cell search in the IS-95 system, all of the BSs are synchronized to one another by means of Global Positioning System (GPS) satellites. The BSs transmit on the pilot channels the same PN code with different offsets. The MS correlates a received signal over a search window of a size equal to the length of the PN code, while shifting the search window. The MS acquires a PN code phase having the greatest correlation and thus identifies its serving BS.

The IS-95 system has evolved into the 3^{rd} generation (3G) mobile communication systems. One of is the 3G system is the Universal Mobile Telecommunication System (UMTS). Although the UMTS system works in CDMA, it is characterized by asynchronous operations among Node Bs.

In a cell search in the UMTS system, every Node B is allocated a cell identification code specific to the Node B. Assuming that the UMTS system has 512 cells and one Node B exists in each cell, there are 512 Node Bs in the UMTS system and each Node B is allocated a different cell identification code. To search for a serving Node B, a user equipment (UE) must search all of the 512 Node Bs on a one-by-one basis. Because it takes a great amount of time to check the phases of the 512 cell identification codes on the one-by-one basis, the UMTS system adopts a multi-step cell search algorithm. For instance, the 512 Node Bs are divided into a predetermined number of groups, for example, 64 groups. Each group is allocated a different group code, for group identification, and 8 Node Bs in each group are distinguished by spreading codes (or scrambling codes) used for their common pilot channels (CPICHs). Thus, the UE first acquires a Node B group and then correlates a received CPICH with the scrambling codes of the Node Bs within the Node B group, thereby identifying a Node B.

The 3^{rd} generation mobile communication systems are now being developed toward 4^{th} generation (4G) mobile communication systems. A standardization organization recommends Orthogonal Frequency Division Multiplexing (OFDM) for the 4^{th} generation mobile communication systems. OFDM is a special case of Multi-Carrier Modulation (MCM) in which a serial symbol sequence is converted to parallel symbol sequences and modulated to mutually orthogonal subcarriers or sub-channels, prior to transmission.

The first MCM systems appeared in the late 1950's for military high frequency (HF) radio communication, and OFDM with overlapping orthogonal subcarriers was initially developed in the 1970's. In view of difficulty in maintaining orthogonal modulation between the multiple carriers, OFDM has its limitations in applications to real systems.

However, in 1971, Weinstein, et al. proposed an OFDM scheme that applies Discrete Fourier Transform (DFT) to parallel data transmission as an efficient modulation/demodulation process, which was a driving force behind the development of OFDM. Also, the introduction of a guard interval and a cyclic prefix as a specific guard interval further mitigated adverse effects of multipath propagation and delay spread on systems.

Accordingly, OFDM has been exploited in wide fields of digital data communications such as Digital Audio Broadcasting (DAB), digital TV broadcasting, Wireless Local Area Network (WLAN), and Wireless Asynchronous Transfer Mode (WATM). Although hardware complexity was an obstacle to the widespread use of OFDM, recent advances in digital signal processing technology including Fast Fourier Transform (FFT) and Inverse Fast Fourier Transform (IFFT) have enabled OFDM implementation.

OFDM, similar to Frequency Division Multiplexing (FDM), boasts optimum transmission efficiency in high-speed data transmission because first of all, OFDM transmits data on subcarriers, maintaining orthogonality among them. Especially, efficient frequency use attributed to overlapping frequency spectrums and robustness against frequency selective fading and multipath fading further increase the transmission efficiency in high-speed data transmission. OFDM reduces the effects of Inter-Symbol Interference (ISI) through the use of guard intervals and enables the design of a simple equalizer hardware structure. Furthermore, since OFDM is robust against impulsive noise, it is increasingly utilized in communication system configurations.

Compared to the afore-mentioned conventional systems, the OFDM communication system distinguishes cells by pilot subcarriers. Data subcarriers and pilot subcarriers are spread with orthogonal codes. A different orthogonal code is used for pilot subcarriers in different BSs. The number of identifiable BSs is limited by the spreading factor (SF) of orthogonal codes used. To identify more Node Bs, a total time-frequency area (or resources) allocated to each Node B is divided into smaller time-frequency areas each being allocated a different spreading code for pilot subcarriers, and a Node B is identified by a sequence of orthogonal codes used for the pilot subcarriers. An orthogonal code used for spreading can be detected through correlation. Since the pilot subcarriers are transmitted with high power relative to the data subcarriers, a receiver decides an orthogonal code having the highest correlation value as one for a pilot subcarrier.

Since a cell search is the process of searching for a BS to communicate with, the cell search is very significant to any mobile communication system. The channel environment of wireless communications is severely degraded by a fading-incurred power change of a received signal, shadowing, Doppler effect caused by the movement of an MS and a frequent change in mobile velocity, and interference from other users and multipath signals as well as Additive White Gaussian Noise (AWGN). Accordingly, there exists a need for a technique for increasing cell search performance under this adverse channel environment.

### SUMMARY OF THE INVENTION

While many cell search algorithms have been proposed for the first, second and third generation mobile communication systems, only the basic concept is outlined and a method of effectively increasing cell search performance is yet to be developed for the OFDM communication system which is developing into the future-generation mobile communication system. That is, a pressing need exists for an efficient cell search technique for the OFDM communication system.

An object of the present invention is to substantially solve at least the above problems and/or disadvantages and to provide at least the advantages below. Accordingly, an object of the present invention is to provide a cell search apparatus and method in an OFDM mobile communication system.

Another object of the present invention is to provide an apparatus and method for increasing cell search performance in an OFDM mobile communication system.

A further object of the present invention is to provide an apparatus and method for increasing the performance of symbol synchronization acquisition, frame synchronization acquisition, and BS identification code detection in an OFDM mobile communication system.

The above objects are achieved by providing a cell search apparatus and method in an OFDM mobile communication system.

According to one aspect of the present invention, in a cell search apparatus in an OFDM mobile communication system, a symbol synchronization acquirer acquires OFDM symbol synchronization by performing cyclic prefix (CP) correlation for a plurality of OFDM symbol intervals. A frame cell synchronization acquirer sorts received OFDM symbols according to the acquired OFDM symbol synchronization, and acquires frame cell synchronization by performing preamble correlation for a plurality of frame cell intervals. A pilot pattern detector sorts received frame cells according to the acquired frame cell synchronization, and detects a pilot pattern for identifying a base station by monitoring a plurality of frame cells.

According to another aspect of the present invention, in a cell search method in an OFDM mobile communication system, OFDM symbol synchronization is acquired by performing CP correlation for a plurality of OFDM symbol intervals, received OFDM symbols are sorted according to the acquired OFDM symbol synchronization, and frame cell synchronization is acquired by performing preamble correlation for a plurality of frame cell intervals. Received frame cells are then received according to the acquired frame cell synchronization, and a pilot pattern for identifying a base station is detected by monitoring a plurality of frame cells.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates time-frequency resource allocation in a Frequency Hopping-Orthogonal Frequency Code Division Multiple Access (FH-OFCDMA) communication system according to an embodiment of the present invention;

FIG. 2 illustrates a forward channel structure in the FH-OFCDMA communication system according to an embodiment of the present invention;

FIG. 3 is a block diagram of channel transmitters in the FH-OFCDMA communication system according to an embodiment of the present invention;

FIG. 4 is a block diagram of a transmitter for transmitting a plurality of channel signals generated from the channel transmitters illustrated in FIG. 3;

FIG. 5 is a block diagram of a receiver in the FH-OFCDMA communication system according to an embodiment of the present invention;

FIG. 6A is a block diagram of a cell search apparatus in the FH-OFCDMA communication system according to an embodiment of the present invention;

FIG. 6B is a detailed block diagram of a symbol synchronization acquirer according to an embodiment of the present invention;

FIG. 6C is a detailed block diagram of a frame cell (FC) synchronization acquirer according to an embodiment of the present invention;

FIG. 6D is a detailed block diagram of a pilot pattern detector according to an embodiment of the present invention;

FIG. 7A is a flowchart illustrating a symbol synchronization acquisition procedure according to an embodiment of the present invention;

FIG. 7B is a flowchart illustrating an FC synchronization acquisition procedure according to an embodiment of the present invention;

FIG. 7C is a flowchart illustrating a pilot pattern detection procedure according to an embodiment of the present invention;

FIG. 8 is a flowchart illustrating an overall cell search procedure in an MS in the FH-OFCDMA communication system according to an embodiment of the present invention; and

FIG. 9 is a flowchart illustrating an overall cell search procedure in the MS in the FH-OFCDMA communication system according to an alternative embodiment of the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

Before describing the present invention, a description will be made illustrating how to utilize time-frequency resources according to a multiple access scheme in an OFDM communication system.

Broad-band spectrum resources are required to provide high-speed, high-quality wireless multimedia services that the future-generation mobile communication system targets. However, the use of the broad-band spectrum resources increases the negative effects of fading on a wireless transmission path due to multipath propagation and brings about the effects of frequency selective fading within a transmission band. In this context, OFDM, which is robust against frequency selective fading, offers a higher gain than CDMA in the high-speed wireless multimedia service, and thus it has recently become an active study area.

In general, OFDM has good spectrum efficiency due to the spectral overlap between mutually orthogonal subcarriers, that is, subcarrier channels. OFDM modulation and demodulation are implemented by IFFT and FFT, respectively. OFDMA is a multiple access scheme based on OFDM, in which some of the subcarriers are allocated to particular MSs. OFDMA is characterized in that no spreading sequences are needed for spectrum spreading, and a set of subcarriers allocated to a particular MS can be dynamically changed according to the fading characteristic of a wireless transmission path. This is referred to as “dynamic resource allocation”. Frequency Hopping (FH) is an example of dynamic resource allocation.

Meanwhile, multiple access schemes requiring spreading sequences are classified into spreading in the time domain and spreading in the frequency domain. A user signal for an MS is spectrum-spread in the frequency domain and mapped to subcarriers in the former case, whereas the user signal is demultiplexed in the frequency domain, mapped to subcarriers, IFFT-processed, and identified by an orthogonal sequence in the time domain in the latter case.

A multiple access scheme according to the present invention uses a composite of properties of OFDM-based multiple access, CDMA, and FH used to achieve robustness against frequency selective fading. This system will be referred to as “FH-OFCDMA” or frequency-hopping orthogonal frequency code division multiple access.

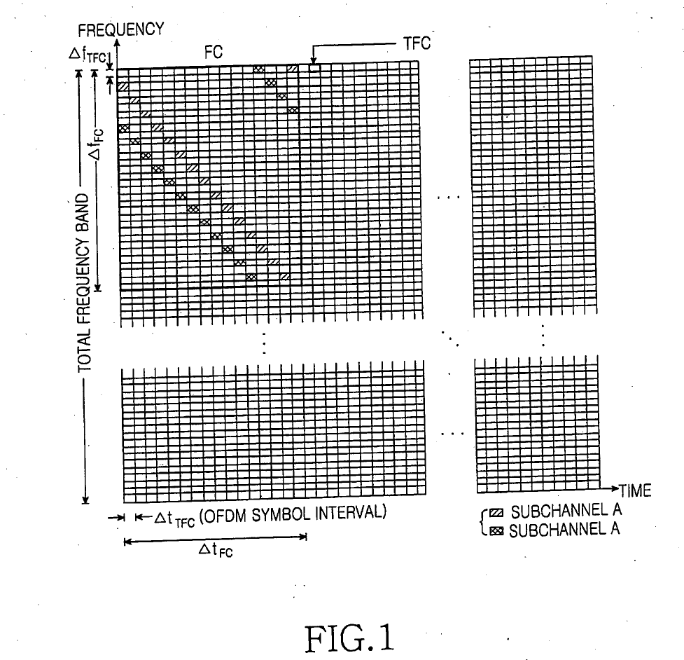

FIG. 1 illustrates an example of time-frequency resource allocation in an FH-OFCDMA communication system according to an embodiment of the present invention.

Referring to FIG. 1, a unit square represents a time-frequency cell (TFC) with a predetermined number of (e.g. 8) subcarriers, which lasts for the duration of an OFDM symbol interval. The number of subcarriers per TFC may vary depending on system implementation. In accordance with the present invention, data mapped to TFCs are processed in the CDMA system, allocated to corresponding subcarriers, and processed in OFDM. The CDMA processing refers to spreading the data with channelization codes for the respective subcarriers. The data could instead be scrambled with scrambling codes. For an SF of 8, seven data and one pilot are spread with different channelization codes and summed on a chip-by-chip basis. The resulting spread data of length 8 are allocated to eight subcarriers forming one TFC. A frame cell (FC) is defined as a time-frequency area with a bandwidth Δf_{FC} being a multiple of the TFC, for example, a 32 multiple, and having a frame duration of Δt_{FC} being a multiple of the TFC, for example, a 16 multiple. Up to the total bandwidth can be allocated to one FC. That is, resources defined by the total frequency band and a number of (e.g. 16) OFDM symbol intervals can be set as an FC. If Adaptive Modulation and Coding (AMC) is applied, a Modulation and Coding Scheme (MCS) is used on an FC basis in order to prevent frequent report of measurements in relation to wireless transmission.

In the illustrated case of FIG. 1, two subchannels A and B are defined in one FC. A subchannel refers to a channel that hops over a number of TFCs in frequency over time in a frequency hopping pattern. Needless to say, the number of TFCs per subchannel and the frequency hopping pattern are variable depending on system implementation. In the present invention, it is assumed that 16 TFCs form one subchannel, and will be used throughout as an example. The two different subchannels are allocated to different MSs or to one MS.

The following description is made on the assumption that an FC covers the total frequency band and 16 OFDM symbol intervals, each of the OFDM symbols uses a different orthogonal code for pilots, and an MS identifies a BS by acquiring a preset number of orthogonal codes used for the pilots.

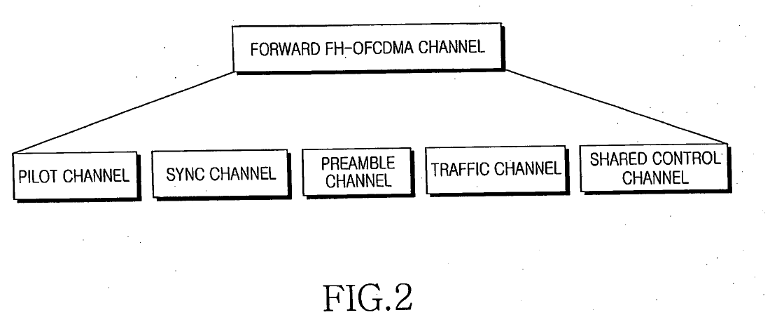

FIG. 2 illustrates a forward channel structure in the FH-OFCDMA communication system according to an embodiment of the present invention.

Referring to FIG. 2, the forward channels used in the FH-OFCDMA communication system, “FORWARD FH-OFCDMA CHANNEL” includes a pilot channel, a sync channel, a traffic channel, and a shared control channel. It can further include a preamble channel. The FORWARD FH-OFCDMA CHANNEL structure will be described in detail later. The pilot channel is used for BS acquisition and channel estimation in the MS. The MS acquires BS information and timing information from the sync channel. The preamble channel is used basically for frame synchronization. It can be used also for channel estimation during actual communications. The traffic channel carries information data. While the preamble channel is separately configured for frame synchronization in FIG. 2, a preamble sequence of the preamble channel can be transmitted by the preamble sequence of a frame on the traffic channel. The shared control channel carries control information that the receiver needs to receive information data on the traffic channel.

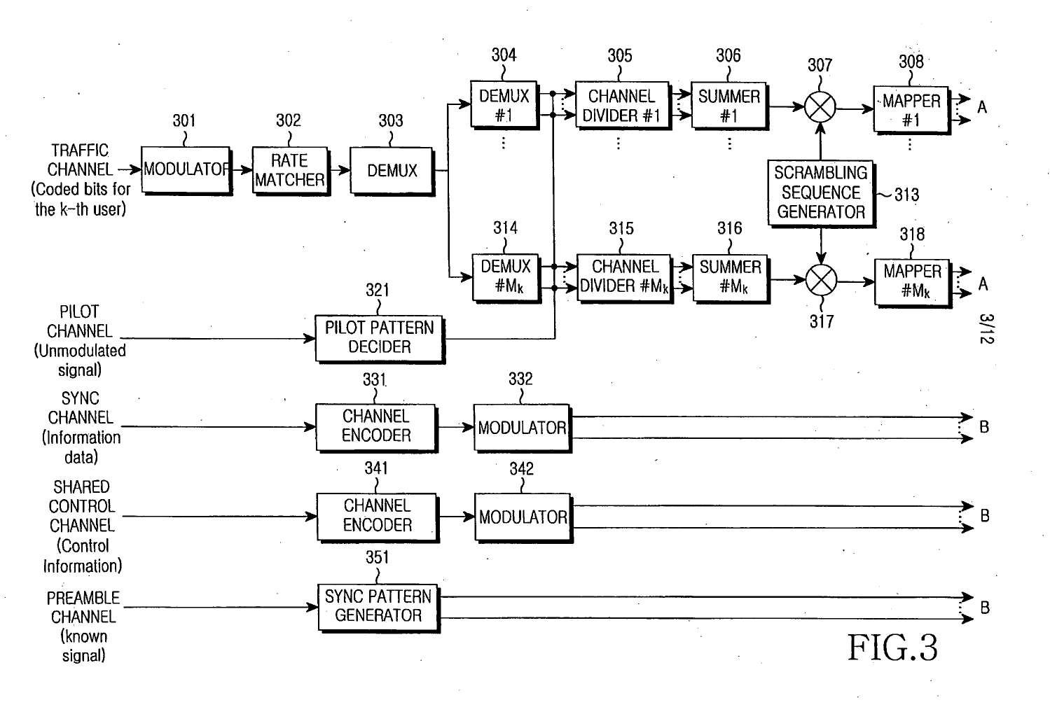

FIG. 3 is a block diagram of channel transmitters in the FH-OFCDMA communication system according to an embodiment of the present invention.

Before describing FIG. 3, it is to be appreciated that the illustrated channel transmitters are viable only if the FH-OFCDMA communication system adopts the forward channels described in FIG. 2. When the forward channels are changed, a corresponding modification is made to the configuration of the channel transmitters.

The channel transmitters illustrated in FIG. 3 will be described separately in connection to the respective forward channels.

Regarding a traffic channel transmitter for transmitting information data, that is, user data on the traffic channel, a stream of coded bits for a k^{th} MS is provided to a modulator 301, after channel coding. The modulator 301 modulates the coded bits in a predetermined modulation scheme according to the status of a wireless transmission path. The modulation scheme can be Quadrature Phase Shift Keying (QPSK), 16-ary Quadrature Amplitude Modulation (16QAM), or 64QAM. If the AMC scheme is used in the FH-OFCDMA communication system, the modulation scheme is changed under the control of the controller (not shown).

A rate matcher 302 rate-matches the modulation symbols received from the modulator 301 to be suitable for transmission on an actual physical channel, that is, the traffic channel, by repetition or puncturing. A demultiplexer (DEMUX) 303 demultiplexes the rate-matched modulation symbol sequence into a number of modulation symbol sequences equal to the number of subchannels, Mₖ used to service the k^{th} MS. Mₖ is one of integers 1 to 16 and k ranges from 1 to K. K is the maximum number of serviceable MSs. The modulation symbol sequence for each subchannel output from the DEMUX 303 has a preset time duration irrespective of the time duration of the modulation symbol sequence input to the DEMUX 303.

For transmission of the modulation symbol sequences output from the DEMUX 303 on different subchannels, up to Mₖ subchannel transmitters are required, as illustrated in FIG. 3. The subchannel transmitters operate in the same manner, except that they receive different modulation symbol sequences. Hence, only one of the subchannel transmitters will be described. Meanwhile, one or more subchannels can be allocated to a traffic channel for each MS. Therefore, one or more subchannel transmitters are used for traffic channel transmission for the MS.

The DEMUX 303 provides the modulation symbol sequences to Mₖ DEMUXes 304 to 314, DEMUX #1 to DEMUX #Mₖ. For example, a modulation symbol sequence for a first subchannel is applied to the input of DEMUX #1. DEMUX #1 demultiplexes the modulation symbol sequence into as many modulation symbol sequences as the number m of subcarriers per TFC. m is determined by an SF. If the TFC also carries a pilot, DEMUX #1 outputs (m-1) modulation symbol sequences. The modulation symbol sequences for the subcarriers last for a time duration m times greater than the modulation symbol sequences for the subchannels. A channel divider 305 (channel divider #1) spreads the modulation symbol sequences for the subcarriers with orthogonal sequences of length m. If the TFC also carries a pilot, channel divider #1 spreads seven modulation symbols received from DEMUX #1 and one pilot symbol received from a pilot pattern decider 321 with different orthogonal sequences. A summer 306 (summer #1) sums the chip-level spread sequences for the respective subcarriers, on a chip-by-chip basis, thereby creating one sequence of length m. A scrambler 307 scrambles the sequence with a scrambling code generated from a scrambling sequence generator 313. A mapper 308 (mapper #1) maps the scrambled signal to a corresponding TFC in the first subchannel. The subcarriers of the subchannel can be dynamically changed in mapper #1 by FH according to the fading characteristic of the wireless transmission path.

While not described in detail, the other subchannel transmitters for transmitting the remaining subchannels operate in the same manner.

Regarding a pilot channel transmitter for transmitting a pilot signal on the pilot channel, the pilot signal is first provided to the pilot pattern decider 321. The pilot signal is an unmodulated sequence. The pilot pattern decider 321 provides the pilot signal to the channel dividers 305 to 315 such that the pilot signal can be spread with a spreading code according to a preset pilot pattern. As described earlier, the pilot pattern represents a sequence of different orthogonal codes and thus a different orthogonal code is mapped to each of the OFDM symbols in one FC. The MS acquires a sequence of orthogonal codes from a received FC and identifies a BS by the orthogonal code sequence. The pilot pattern decider 321 also decides the position of a subcarrier to which the pilot is to be allocated, that is, the position of a subcarrier to have a pilot tone. Therefore, the pilot tone is placed at the decided subcarrier position. The reason for not allocating the pilot signal to all of the subcarriers is to identify more BSs according to pilot positions and to save resources.

As described before, the transmitter (i.e. the BS) transmits pilot subcarriers (i.e. pilot channel signals) to the MS in the OFDM communication system, so that the MS can perform synchronization acquisition, channel estimation, and BS identification. The pilot channel signals are a kind of training sequence. They allow the receiver to carry out channel estimation between the transmitter and the receiver and to identify the serving BS. The positions of the pilot channel signals are preset between the transmitter and the receiver. Consequently, the pilot channel signals serve as a reference signal.

The BS transmits the pilot channel signals in a preset pilot pattern with greater transmit power than the data channel signals. When the MS enters the cell, it has no prior knowledge of the serving BS and has to use the pilot channel signals to identify the serving BS. Therefore, the BS transmits the pilot channel signals in the pilot pattern with relatively high transmit power enough to reach a cell boundary, so that the MS can identify the BS.

The pilot pattern is a pattern in which the BS generates the pilot channel signals. It is determined by a number of orthogonal codes with which to spread the pilot channel signals. For BS identification, a different pilot pattern is designed for each BS in the OFDM communication system. Thus, the MS identifies its serving BS by the pilot pattern of the BS. While not shown in FIG. 3, the traffic channel and the pilot channel are spread with different orthogonal codes, prior to transmission.

Regarding a sync channel transmitter for transmitting information data on the sync channel, a channel encoder 631 encodes the information data in a predetermined coding method. A modulator 332 modulates the coded information data in a predetermined modulation scheme and outputs the modulated signal as a sync channel signal.

Regarding a shared control channel transmitter for transmitting control information on the shared control channel, a channel encoder 341 encodes the control information in a predetermined coding method. A modulator 342 modulates the coded information data in a predetermined modulation scheme and outputs the modulated signal as a shared control channel signal.

Finally, regarding a preamble channel transmitter for transmitting a preamble sequence on the preamble channel, a sync pattern generator 351 generates a preamble sequence in a predetermined pattern, by which the MS can acquire preamble synchronization. The predetermined pattern refers to a repetition pattern of the preamble sequence. There are two types of preamble sequences: a short preamble sequence and a long preamble sequence. Depending on system situation, the short preamble sequence or the long preamble sequence is repeated. This repetition pattern is determined by the sync pattern generator 351.

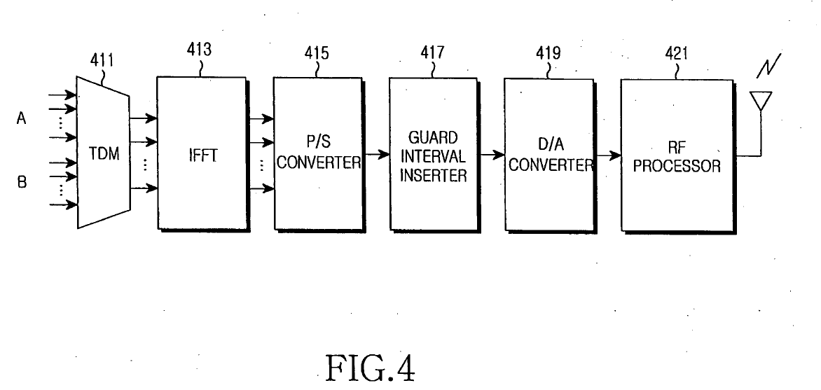

FIG. 4 is a block diagram of a transmitter for transmitting a plurality of channel signals generated from the channel transmitters illustrated in FIG. 3. The following description is made with the appreciation that the operation of the illustrated transmitter takes places subsequent to the operations of the channel transmitters illustrated in FIG. 3.

Reference characters A and B denote connections between the channel transmitters of FIG. 3 and the transmitter of FIG. 4. Hence, traffic channel data, pilot channel data, sync channel data, and shared control channel data for each subchannel are received in the transmitter through the input port A. The transmitter receives preamble channel data from the preamble channel transmitter through the input port B.

Referring to FIG. 4, the signals output from the channel transmitters are provided to a time division multiplexer (TDM) 411 through the input ports A and B. The TDM 411 time-division-multiplexes the traffic channel signal, the pilot channel signal, the sync channel signal, the shared control channel signal, and the preamble channel signal. Referring to FIG. 1, one FC has 16 OFDM symbols on the time axis. The TDM 411 selects the preamble channel signal in the first of the 16 OFDM symbol intervals and the other channel signals in the other OFDM symbol intervals.

An IFFT processor 413 IFFT-processes the signal received from the TDM 411. A parallel-to-serial (P/S) converter 415 serializes the IFFT signals. A guard interval inserter 417 inserts a guard interval into the serial signal to eliminate interference between an OFDM symbol sent in the previous OFDM symbol interval and the current OFDM symbol to be sent in the current OFDM symbol interval. It was originally proposed that null data is inserted as the guard interval. The distinctive shortcoming of this guard interval is that in case of wrong estimation of the start of the OFDM symbol at the receiver, interference occurs between subcarriers, which in turn increases the wrong decision probability of the received OFDM symbol. Therefore, the guard interval is used in the form of a “cycle prefix” or “cyclic postfix”. The cyclic prefix is a copy of some last bits of a time-domain OFDM symbol, inserted into an effective OFDM symbol, and the cyclic postfix is a copy of some first bits of the time-domain OFDM symbol, inserted into the effective OFDM symbol.

A digital-to-analog (D/A) converter 419 converts the guard interval-having signal to an analog signal. A radio frequency (RF) processor 421, which includes a filter and a front-end unit, processes the analog signal to an RF signal transmittable over the air and transmits it over the air through an antenna.

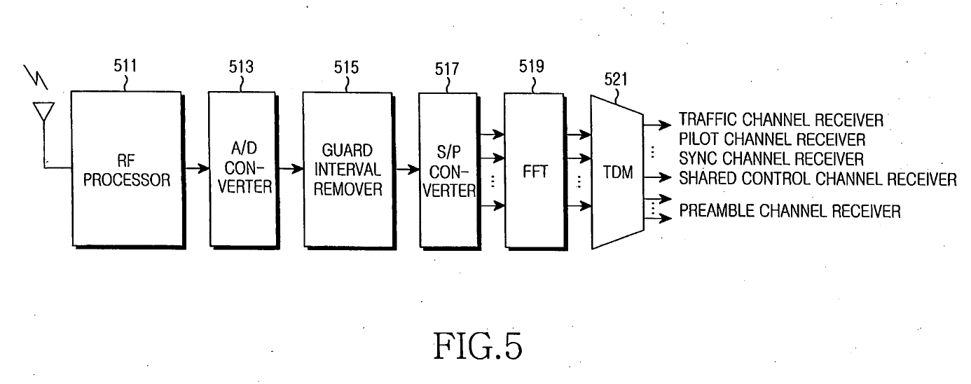

FIG. 5 is a block diagram of a receiver in the FH-OFCDMA communication system according to an embodiment of the present invention.

Referring to FIG. 5, a signal transmitted by the transmitter experiences a real radio channel environment like a multipath channel and is added with noise before arriving at an antenna of the receiver in the FH-OFCDMA communication system. An RF processor 511 downconverts the received signal to an intermediate frequency (IF) signal and then to a baseband signal. An analog-to-digital (AID) converter 513 converts the analog signal received from the RF processor 511 to a digital signal.

A guard interval remover 515 eliminates a guard interval from the digital signal. A serial-to-parallel (S/P) converter 517 parallelizes the serial signal received from the guard interval remover 515. An FFT processor 519 N-point FFT-processes the parallel signals. A TDM 521 time-division-multiplexes the FFT signals and outputs the multiplexed traffic channel signal, pilot channel signal, sync channel signal, and shared control channel signal to a traffic channel receiver, a pilot channel receiver, a sync channel receiver, and a shared control channel signal receiver, respectively. These channel receivers demodulate the channel signals in the reverse order of the transmission operations of the traffic channel transmitter, the pilot channel transmitter, the sync channel transmitter, and the shared control channel transmitter illustrated in FIG. 3. While not shown, the channel receivers are configured to operate in the reverse order of the channel transmission operations. Since the channel receivers are configured for one MS only, they operate using channelization codes and a scrambling code corresponding to the MS, as compared to the channel transmitters which operate for a plurality of MSs.

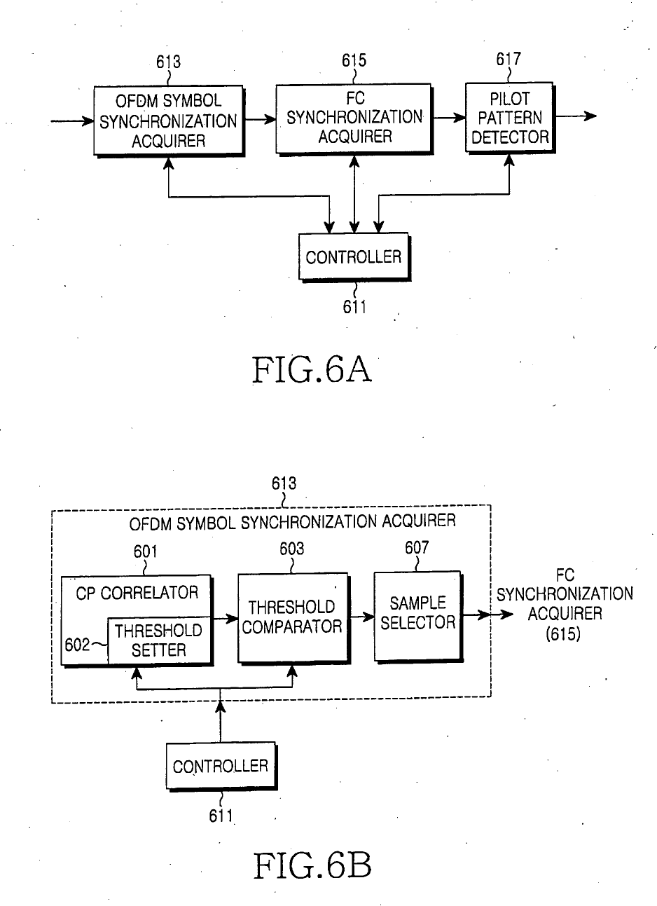

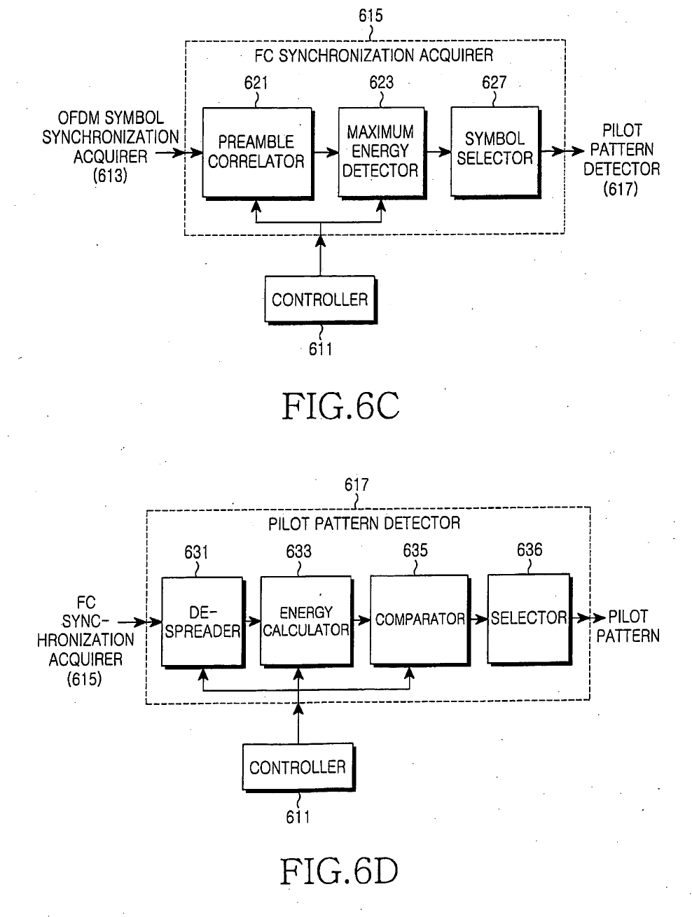

FIGS. 6A through 6D are detailed block diagrams of a cell search apparatus in the FH-OFCDMA communication system according to an embodiment of the present invention.

Before describing the cell search apparatus, a description will first be made of the reasons for using the cell search in the FH-OFCDMA communication system.

Upon power-on, an MS acquires a particular BS and attempts communications on the reverse link via an access channel. However, the MS has no prior knowledge of a serving BS, when power is on. Therefore, the MS needs to search for the serving BS, that is, the serving cell, for communications.

Referring to FIG. 6A, a controller 611 provides overall control to the cell search apparatus. An OFDM symbol synchronization acquirer 613 acquires OFDM symbol synchronization using the guard interval of a received OFDM symbol. As described earlier, the guard interval is inserted to eliminate interference between an OFDM symbol sent in the previous OFDM symbol interval and an OFDM symbol to be sent in the current OFDM symbol interval. It takes the form of a “cycle prefix” or “cyclic postfix”. The cyclic prefix is a copy of some last bits of a time-domain OFDM symbol, inserted into an effective OFDM symbol, and the cyclic postfix is a copy of some first bits of the time-domain OFDM symbol, inserted into the effective OFDM symbol. For the examples set forth herein, the guard interval is assumed to be a cyclic prefix. Thus, the OFDM symbol synchronization acquirer 613 correlates the guard interval with predetermined last bits of the received OFDM symbol, detects a peak value equal to or exceeding a threshold, and acquires the OFDM symbol synchronization based on the timing corresponding to the peak value. This timing is the OFDM symbol timing, that is, OFDM symbol boundary of the serving BS. Detection of the OFDM symbol timing is the acquisition of OFDM symbol synchronization. Thus, it is possible to perform FFT by detecting an FFT start point.

Upon receipt of an OFDM symbol timing detection signal from the OFDM symbol synchronization acquirer 613, that is, upon acquisition of the OFDM symbol synchronization, the controller 611 controls an FC synchronization acquirer 615 to acquire FC synchronization in synchronization to the OFDM symbol timing.

The FC synchronization acquirer 615 searches for an FC start point (i.e. FC boundary) using the preamble channel signal. A pilot pattern by which to identify the BS starts from the FC start point and is repeated or changed on an FC basis. That is why the FC start point is detected. When a preamble channel exists between successive pilot channels (the preamble channel has no pilot subcarriers in the present invention), there is a probability of estimating a wrong pilot pattern. Hence, the FC start point must be detected. As described above, since the same preamble sequence is repeated a plurality of times on the preamble channel, a peak value equal to or exceeding a threshold is detected by correlating the repeated sequences and the timing with the peak value is determined to be the FC start point. Alternatively, if the MS has prior knowledge of the preamble sequence, the MS searches for the FC start point by correlating the received signal with the preamble sequence. The procedure of detecting the FC start point will be described in greater detail below.

Assuming that the MS receives signals from a first base station BS 1 and a second base station BS 2, it is impossible for the MS to determine whether the received signals are data or preamble signals. Yet, the MS can determine if the received signals are repeated. If the signal is repeated, the MS correlates with the repeated signals and detects a timing with a peak value equal to or greater than a threshold as an FC start point.

Upon receipt of an FC sync acquisition signal from the FC synchronization acquirer 615, the controller 611 controls a pilot pattern detector 617 to detect a pilot pattern in synchronization to the FC start point. Notably, the pilot pattern can be detected only with the acquired OFDM symbol synchronization, without acquiring the FC synchronization. To be more specific, the FC start point is detected using the preamble channel signal because the pilot pattern may not be detected accurately due to the preamble channel signal. If this case can be avoided or the right pilot pattern can be detected using only two pilot signals, there is no need for detecting the FC start point. Then, the FC synchronization acquirer 615 does not need to be provided. The pilot pattern detector 617 detects the spreading codes of the pilot channel signals by asynchronous energy detection and identifies a BS by the sequence of orthogonal codes. The operation of the pilot pattern detector 617 will be described below in more detail.

The received signal is converted to a frequency-domain signal by FFT at the OFDM symbol timing acquired by the OFDM symbol synchronization acquirer 613. The pilot pattern detector 617 then detects the spreading code of the received pilot signal from the frequency-domain signal through asynchronous energy detection. Because pilot signals are transmitted with high transmit power enough to reach a cell boundary, relative to other channel signals, they are detected with peak values despite the asynchronous energy detection. After detecting the spreading codes of the pilot signals, the pilot pattern detector 617 detects a pilot pattern from the spreading codes. The controller 611 compares the detected pilot pattern with pilot patterns listed in a table in an internal memory (not shown) of the controller 611. In the presence of a matched pilot pattern, the MS identifies a BS having the pilot pattern as the serving BS. The pilot pattern comparison is performed by correlation. Despite the presence of a pilot pattern matched to the detected one, if the correlation between them is below a threshold, the MS considers that the pilot pattern detection is erroneous and corrects for errors.

FIG. 6B is a detailed block diagram of the OFDM symbol synchronization acquirer 613 according to an embodiment of the present invention.

Referring to FIG. 6B, a cyclic prefix (CP) correlator 601 estimates the CP energy of a signal input to the OFDM symbol synchronization acquirer 613 by differential correlation using a CP repeated every OFDM symbol interval. It correlates over one OFDM symbol interval, moving a sliding window, sample-by-sample and outputs the correlations to a threshold comparator 603. As a general rule, as a CP length is lengthened, a higher correlation is achieved, facilitating OFDM symbol synchronization acquisition. The controller 611 generates a control signal to move the sliding window on a sample-by-sample basis. A threshold setter 602 determines a threshold on a symbol basis and outputs the threshold to the threshold comparator 603. The threshold is set to be greater than the average correlation of the received signal by n dB. The threshold setter 602 can be incorporated into the CP correlator 602, as illustrated in FIG. 6B, or configured separately. The threshold comparator 603 compares the correlations received from the CP correlator 601 with the threshold and outputs sample values (positions and correlations) exceeding the threshold to a sample selector 607. Meanwhile, the controller 611 controls the operations of the CP correlator 601, the threshold setter 602, and the threshold comparator 603 to be repeated over a predetermined number of successive OFDM symbol intervals.

The sample selector 607 decides the position (or timing) of a sample which has the highest correlation recursively in the successive OFDM symbol intervals as a symbol start point (OFDM symbol synchronization). For example, samples with peak values common in the successive OFDM symbol intervals are detected and the position of a sample with the highest correlation among them is set as a symbol start point. Since the correlations of one symbol interval are less reliable due to factors including the channel, a longer monitoring period increases the probability of OFDM symbol synchronization acquisition and the increase rate starts to slow down at a certain time point. Considering this property and required computation volume, the number of OFDM symbols used for symbol synchronization acquisition is determined. The result of the OFDM symbol synchronization acquirer 613 (OFDM symbol synchronization information) is provided to the FC synchronization acquirer 615.

FIG. 6C is a detailed block diagram of the FC synchronization acquirer 615. FC synchronization is acquired using a preamble signal known to both the BS and the MS. While differentiation is used for acquisition of OFDM symbol synchronization, FC synchronization is acquired by correlation.

Referring to FIG. 6C, the controller 611 counts symbol intervals from the sample position (OFDM symbol synchronization) detected by the OFDM symbol synchronization acquirer 613. A preamble correlator 621 correlates the known preamble sequence with a frequency-domain sequence of a predetermined length (i.e. the length of the preamble sequence) based on the count signal received from the controller 611. The resulting correlations are provided to a maximum energy detector 623. Since a monitoring period is determined by the total length of a plurality of FCs, as many correlations as an integer multiple of the number of OFDM symbols per FC are provided to the maximum energy detector 623.

The maximum energy detector 623 compares the correlations in each FC under the control of the controller 611. The monitoring period is predetermined and controlled by the controller 611. The preamble correlator 621 and the maximum energy detector 623 operate once for correlation of one OFDM symbol. Thus, a minimum monitoring period is one FC and the OFDM symbols of the FC must be monitored. For precise FC synchronization, the controller 611 controls the preamble correlator 621 and the maximum energy detector 623 to repeat their operations in order to monitor a plurality of FCs.

A symbol selector 627 stores an OFDM symbol value (symbol position and correlation) with the highest correlation for each FC received from the maximum energy detector 623. The symbol selector 627 then determines if an OFDM symbol with the highest correlation is recursively observed at the same position in the FCs. If it is, the symbol selector 627 sets the OFDM symbol position as an FC start point. In this way, the position of an OFDM symbol with the highest correlation is detected in every FC for a predetermined monitoring period, it is determined if the detected OFDM symbols reside at the same position in the FCs, and the OFDM symbol position is set to be an FC start point, if they are at the same position. In the case of a long monitoring period or continuation of an OFDM symbol with the highest correlation, the accuracy of FC synchronization is increased. On the contrary, in the case of a short monitoring period or discontinuation of an OFDM symbol with the highest correlation, FC synchronization accuracy is decreased. The continuation of an OFDM symbol position implies that the OFDM symbol with the highest correlation resides at the same position in the FCs, whereas the discontinuation of an OFDM symbol position implies that some of the OFDM symbols with the highest correlations are at different positions in the FCs.

FIG. 6D is a detailed block diagram of the pilot pattern detector 617. As described before, a pilot pattern is a sequence of orthogonal codes used for pilot signals.

Referring to FIG. 6D, a despreader 631 despreads FFT signals with spreading codes preset for each TFC. After the despreading, data and pilots spread by the transmitter are detected. Since the pilots are typically transmitted with higher transmit power than the data, they can be easily detected using despreading energy. An energy calculator 633 calculates the energy of the despread signals with respect to each orthogonal code in every time-frequency area. Because the MS has knowledge of the pilot patterns of all of the BSs, it can calculate the energies of the pilot patterns with respect to the respective orthogonal codes. The controller 611 controls the energy calculator 633 to calculate the energies of all possible pilot patterns in an FC.

After energy calculation is completed for each FC, a comparator 635 compares the energy values of all possible pilot patterns from the energy calculator 633 and detects a pilot pattern having the highest energy value or having an energy value exceeding a threshold preset by the controller 611. The controller 611 controls the despreader 631, the energy calculator 633, and the comparator 635 to repeatedly operate for a predetermined number of FCs.

When the above operation is completely performed for the FCs, a plurality of pilot patterns result. A selector 636 selects as a cell ID a pilot pattern with the highest energy, the most frequent pilot pattern, or a pilot pattern detected at least a predetermined number of times. Then the pilot pattern detection is completed. If the monitoring period is long or the same pilot pattern is detected successively, pilot pattern detection becomes more accurate. On the other hand, a shorter monitoring period or detection of insuccessive pilot patterns decreases the accuracy of pilot pattern detection.

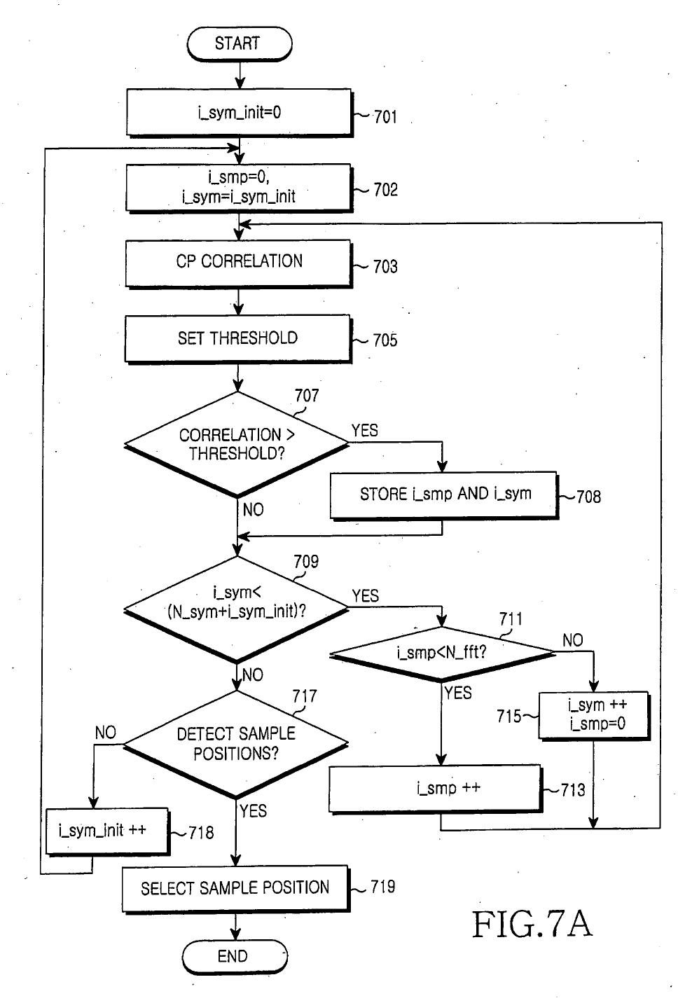

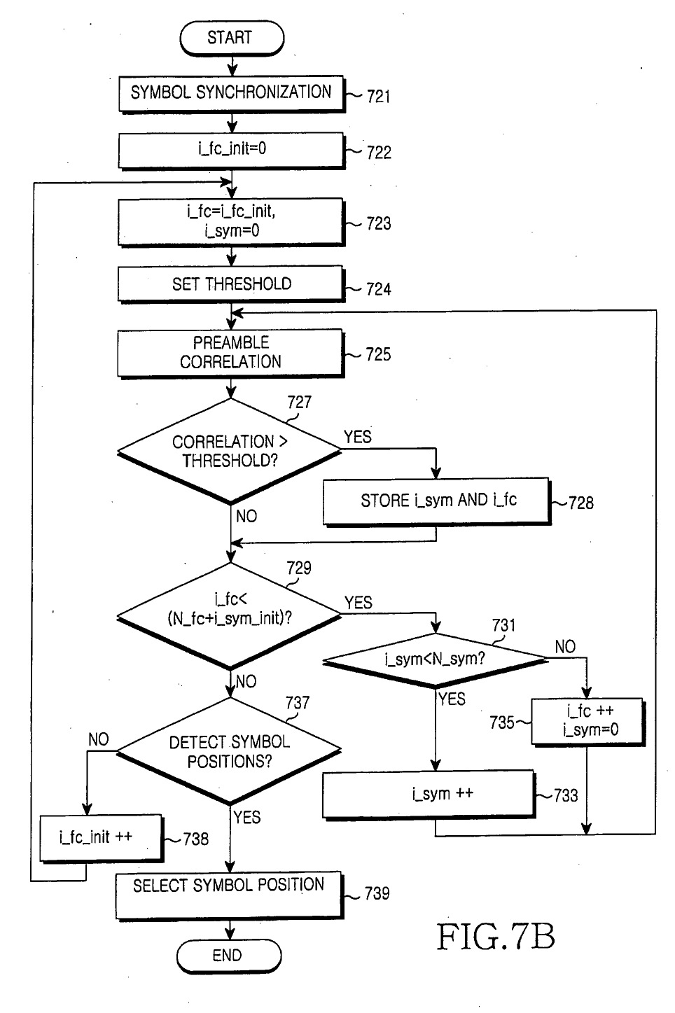

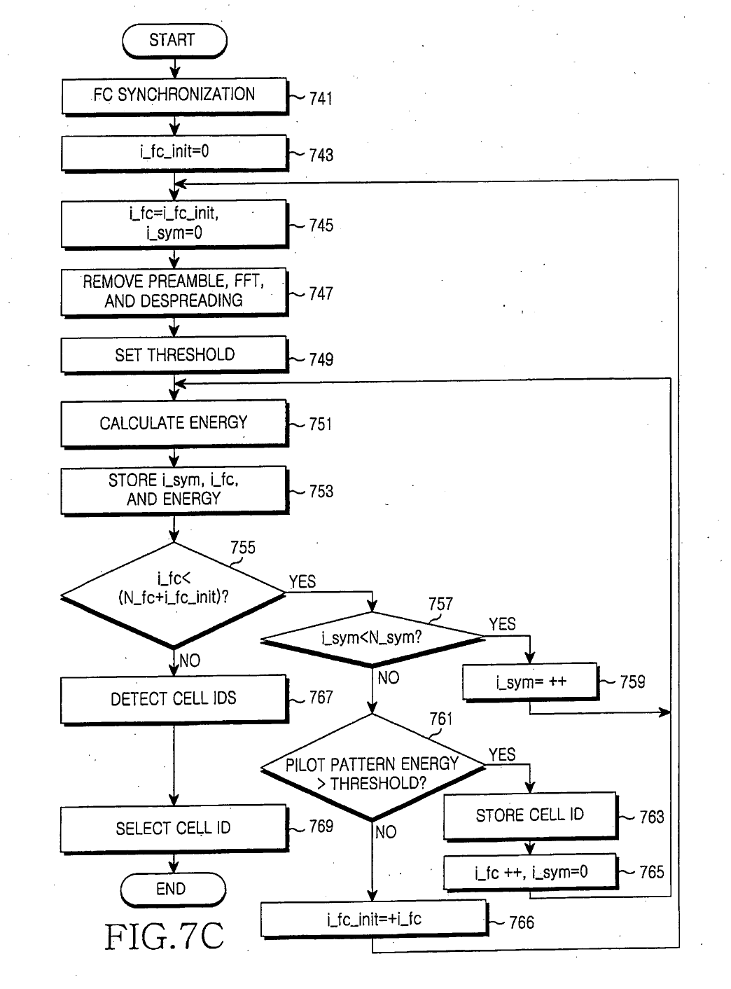

FIGS. 7A, 7B and 7C are flowcharts illustrating the operations of the symbol synchronization acquirer 613, the FC synchronization acquirer 615, and the pilot pattern detector 617, respectively.

FIG. 7A illustrates a symbol synchronization acquisition procedure in the symbol synchronization acquirer 613.

Referring to FIG. 7A, the symbol synchronization acquirer 613 sets a variable i_sym_init representing an initial symbol index to an initial value 0 in step 701. In step 702, a sample index i_smp is set to an initial value 0 and a symbol index i_sym is replaced with i_sym_init. The symbol index i_sym is increased to up to a predetermined symbol index N_sym and the sample index i_smp starts from 0 and increases to up to N_fft.

After the initialization, the symbol synchronization acquirer 613 correlates signals extracted from a predetermined sliding window based on the CP property, while moving the sliding window sample-by-sample according to the sample index i_smp in step 703. In step 705, the symbol synchronization acquirer 613 sets a threshold using on the correlations (or correlation energy values).

The symbol synchronization acquirer 613 compares the correlation of a sample with the threshold in step 707. If the correlation is greater than the threshold, the symbol synchronization acquirer 613 stores the position of the sample (i_smp and i_sym) and its correlation in step 708. If the correlation is less than or equal to the threshold, the symbol synchronization acquirer 613 compares the symbol index i_sym with (N_sym+i_sym_init) in step 709. (N_sym+i_sym_init) represents the number of symbols to be monitored to acquire symbol synchronization. In the present invention, a plurality of symbol intervals are monitored for symbol synchronization acquisition in order to increase the reliability of symbol synchronization.

If i_sym is less than (N_sym+i_sym_init), the symbol synchronization acquirer 613 compares the sample index i_smp with N_fft in step 711. N_fft is an FFT size, that is, the number of samples per symbol. If i_smp is less than N_fft, the symbol synchronization acquirer 613 increases i_smp by 1 in step 713 and returns to step 703. If i_smp is equal to or greater than N_fft, the symbol synchronization acquirer 613 increases i_sym by 1 and sets i_smp to 0 in step 715 and returns to step 703, for sample correlation for the next symbol interval.

Meanwhile, after the correlation is completed over N_sym symbol intervals, the symbol synchronization acquirer 613 checks the stored sample positions and determines if there is a sample position which has a correlation greater than the threshold in a predetermined number of successive symbol intervals in step 717. In the absence of a sample position having a correlation greater than the threshold in the successive symbol intervals, the symbol synchronization acquirer 613 increases i_sym_int by 1 in step 718 and returns to step 702.

In the presence of sample positions which have correlations greater than the threshold in the successive symbol intervals, the symbol synchronization acquirer 613 sets a sample position (index) having the highest correlation as a symbol start point in step 719 and ends this procedure. The symbol start point (symbol synchronization) is used later for acquiring FC synchronization.

FIG. 7B is a flowchart illustrating an FC synchronization acquisition procedure in the FC synchronization acquirer 615.

Referring to FIG. 7B, the FC synchronization acquirer 615 sorts received symbols in synchronization to the symbol timing acquired by the symbol synchronization acquirer 613 in step 721. It sets a variable i_fc_init representing an initial FC index to an initial value 0 in step 722 and replaces an FC index i_fc with i_fc_init and sets a symbol index i_sym to an initial value 0 in step 723. The symbol index i_sym is used to count the symbols of one FC, indicating a symbol for which preamble correlation is performed.

After the initialization, the FC synchronization acquirer 615 sets a threshold for preamble detection in step 724. The threshold is equal to the correlation of a received signal when it is a preamble sequence, or less than the correlation by 1 to 2 dB. In step 725, the FC synchronization acquirer 615 correlates the frequency-domain sequence of a symbol indicated by i_sym with a known preamble sequence. The FC synchronization acquirer 615 compares the correlation with the threshold in step 727. If the correlation is greater than the threshold, the FC synchronization acquirer 615 stores the position of the symbol (i_sym and i_fc) and its correlation in step 728 and proceeds to step 729.

If the correlation is equal to or less than the threshold, the FC synchronization acquirer 615 determines if a predetermined number of FC intervals have been monitored in step 729. In other words, the FC synchronization acquirer 615 determines if i_fc is less than (N_fc+i_fc_init). If i_fc is less than (N_fc+i_fc_init), the FC synchronization acquirer 615 compares i_sym with N_sym in step 731. N_sym represents the number of symbols per FC.

If i_sym is less than N_sym, the FC synchronization acquirer 615 increases i_sym by 1 in step 733 and returns to step 725. If i_sym is equal to or greater than N_sym, the FC synchronization acquirer 615 increases i_fc by 1 and sets i_sym to 0 in step 735 and returns to step 725.

On the other hand, if i_fc is equal to or greater than (N_fc+i_fc_init), the FC synchronization acquirer 615 determines if there is a symbol position with a correlation greater than the threshold in a predetermined number of successive FC intervals among the stored symbol positions in step 737. In the absence of a symbol position having a correlation greater than the threshold in the successive FC intervals, the FC synchronization acquirer 615 increases i_fc_init by 1 in step 738 and returns to step 723. In the presence of symbol positions having correlations greater than the threshold in the successive FC intervals, the FC synchronization acquirer 615 sets a symbol position having the highest correlation among them as an FC start point in step 739 and ends the procedure. The FC start point (FC synchronization) is used to acquire a pilot pattern.

FIG. 7C illustrates a pilot pattern acquisition procedure in the pilot pattern detector 617.

Referring to FIG. 7C, the pilot pattern detector 617 is synchronized to the FC timing acquired by the FC synchronization acquirer 615 in step 741. The pilot pattern detector 617 sets an initial FC index i_fc_init to 0 in step 743 and sets an FC index i_fc to i_fc_init and a symbol index i_sym to an initial value 0 in step 745.

After the initialization, the pilot pattern detector 617 removes a preamble from an FC signal, FFT-processes the FC signal, and despreads the FFT signals with predetermined orthogonal codes in step 747. Since a preamble does not include pilot subcarriers in the FC structure according to the embodiment of the present invention, the preamble is removed as described above. The pilot pattern detector 617 sets a threshold for detecting a pilot pattern in step 749. In general, a pilot signal is transmitted with higher transmit power than data. Thus, the threshold is equal to the average energy of the received signal or higher than the average energy by 1 to 2 dB.

The pilot pattern detector 617 calculates the energies of the (i_sym)^{th} spreading codes of all known pilot patterns using the despread signals of a symbol with index i_sym in an FC with index i_fc. Assuming that the pilot patterns of BS 1 and BS 2 are [C0, C3, C5] and [C2, C4, C8], respectively, the energies of the despread signals of a first symbol with respect to C0 for BS 1 and C2 for BS 2 are calculated. For a second symbol, the energies of C3 for BS 1 and C4 for BS 2 are calculated, and for a third symbol, the energies of C5 for BS 1 and C8 for BS 2 are calculated. In step 753, the pilot pattern detector 617 stores the energy values with respect to i_sym and i_fc.

The pilot pattern detector 617 determines if a predetermined number of FCs have been monitored in step 755. In other words, it determines if i_fc is less than (N_fc+i_fc_init). If i_fc is less than (N_fc+i_fc_init), the pilot pattern detector 617 determines if i_sym is less than N_sym in step 757. N_sym is the number of symbols per FC.

If i_sym is less than N_sym, the pilot pattern detector 617 increases i_sym by 1 in step 759 and returns to step 751. If i_sym is equal to or greater than N_sym, the pilot pattern detector 617 calculates the energy of each pilot pattern and compares the calculated energy with the threshold in step 761. For a pilot pattern [C0, C3, C5] for BS 1, the energy values of the respective codes C0, C3 and C5 are summed and the sum for BS 1 is compared with the threshold.

In the absence of a pilot pattern with an energy greater than the threshold, the pilot pattern detector 617 adds i_fc_init to i_fc in step 766 and returns to step 745. That is, the pilot pattern detector 617 sets an N_fc period following the failed FC and starts to monitor. On the contrary, in the presence of a pilot pattern with an energy greater than the threshold, the pilot pattern detector 617 stores a cell ID corresponding to the pilot pattern and its energy value in step 763. The pilot pattern detector 617 increases i_fc by 1 and sets i_sym to the initial value 0 in step 765 and returns to step 751.

Meanwhile, if i_fc is equal to or greater than (N_fc+i_fc_init) in step 755, the pilot pattern detector 617 checks the stored cell IDs and acquires cell IDs having energy values greater than the threshold in a predetermined number of successive FCs in step 763. In step 769, the pilot pattern detector 617 selects a cell ID with the highest energy among the acquired cell IDs and ends the procedure.

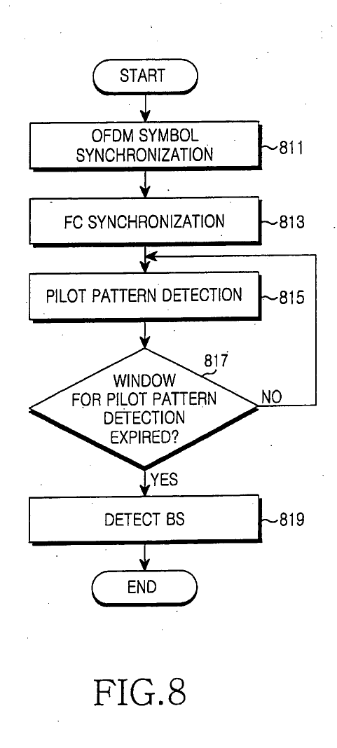

FIG. 8 is a flowchart illustrating an overall cell search procedure in an MS in the FH-OFCDMA communication system according to an embodiment of the present invention.

Referring to FIG. 8, the MS acquires OFDM symbol synchronization by monitoring a plurality of OFDM symbol intervals in step 811. To be more specific, the MS correlates a guard interval with a predetermined number of last bits of an OFDM symbol on an OFDM symbol interval basis using a sliding window, acquires sample positions having peak values repeatedly in a predetermined number of successive OFDM symbols by comparing the correlations with a threshold, and sets a sample position with the highest correlation as a symbol start point. Since a cyclic prefix is assumed, the guard interval is correlated with the last bits of the OFDM symbol. In this way, the reliability of symbol synchronization is increased by monitoring a plurality of OFDM symbol intervals.

After the symbol synchronization acquisition, the MS sorts received symbols in accordance with the symbol synchronization and acquires FC synchronization by monitoring a plurality of FC intervals in step 813. To be more specific, each OFDM symbol is correlated with a known preamble sequence for the FC intervals, a symbol position with the highest correlation is detected in each FC interval, and an FC start point is set by checking if OFDM symbols with the highest correlations are at the same position repeatedly in the FC intervals. In this way, the performance of FC synchronization acquisition is increased by monitoring a plurality of FC intervals.

In step 815, the MS sorts received FCs in accordance with the FC synchronization and acquires a pilot pattern by monitoring a plurality of FCs. Specifically, the MS detects a sequence of orthogonal codes used for pilots in each FC and compares the detected orthogonal code sequence with known pilot patterns. The comparison is performed by correlation. Despite the presence of a pilot pattern matching the orthogonal code sequence, if the correlation of the orthogonal code sequence is below a threshold, the MS determines that the pilot pattern detection is failed and corrects errors.

In step 817, the MS determines if a window period to be searched for pilot pattern detection has expired. If the window period does not expire, the MS returns to step 815 and continues the pilot pattern detection. If the window period has expired, the MS detects a BS using the decided pilot pattern in step 819 and ends the procedure. In this way, the MS acquires a pilot pattern in each FC and determines if the detected pilot patterns are identical, to thereby acquire a pilot pattern. The performance of pilot pattern detection is increased by monitoring a plurality of FCs.

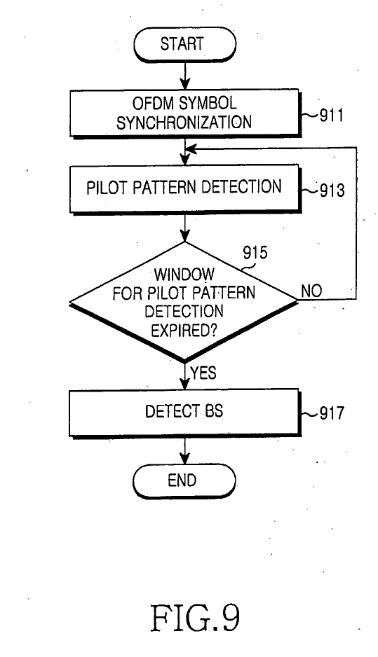

FIG. 9 is a flowchart illustrating an overall cell search procedure in the MS in the FH-OFCDMA communication system according to an alternative embodiment of the present invention.

Step 911 is performed in the same manner as step 811 of FIG. 8, and steps 913 to 917 as steps 815 to 819 of FIG. 8. Thus, their description is not provided. Yet, one thing to note here is that a step corresponding to step 813 of FIG. 8 is not performed in the procedure of FIG. 9. While the FC start point is detected in step 813 because the preamble channel signal may lead to inaccurate pilot pattern detection, if this case can be avoided or an accurate pilot pattern can be detected using two pilot signals only, step 813 is not needed. That's why the FC start point detection is not carried out in FIG. 9.

As described above, the present invention enables an efficient, accurate cell search by increasing the performances of OFDM symbol timing detection, FC start detection, and pilot pattern detection in an FH-OFCDMA mobile communication system. Also, a multi-step cell search using OFDM symbol timing, an FC start point, and a pilot pattern according to the present invention minimizes computation volume required for cell search and is easily implemented in hardware.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A cell search apparatus in an orthogonal frequency division multiplexing (OFDM) mobile communication system, comprising:
a symbol synchronization acquirer for acquiring OFDM symbol synchronization by performing cyclic prefix (CP) correlation for a plurality of OFDM symbol intervals;
a frame cell synchronization acquirer for sorting received OFDM symbols according to the acquired OFDM symbol synchronization, and acquiring frame cell synchronization by performing preamble correlation for a plurality of frame cell intervals; and
a pilot pattern detector for sorting received frame cells according to the acquired frame cell synchronization, and detecting a pilot pattern for identifying a base station by monitoring a plurality of frame cells.

2. The cell search apparatus of claim 1, wherein the symbol synchronization acquirer includes:
a first detection unit for detecting a peak by performing CP correlation on one OFDM symbol interval;
a controller for controlling the peak detection of the first detection unit to be repeated a preset number of times for the plurality of OFDM symbols; and
a sample selector for selecting as an OFDM symbol start a sample position repeatedly having a peak in the plurality of OFDM symbol intervals.

3. The cell search apparatus of claim 2, wherein the first detection unit includes:
a correlator for outputting correlations by performing CP correlation for one OFDM symbol interval in a sliding window method; and
a comparator for comparing the correlations with a threshold and outputting to the sample selector sample positions having correlations greater than the threshold.

4. The cell search apparatus of claim 2, wherein if a plurality of sample positions repeatedly have peaks in the plurality of OFDM symbol intervals, the sample selector selects as the OFDM symbol start a sample position having the highest correlation among the sample positions.

5. The cell search apparatus of claim 1, wherein the frame cell synchronization acquirer includes:
a second detection unit for sorting the received OFDM symbols according to the acquired OFDM symbol synchronization and detecting a peak by correlating frequency-domain signals of OFDM symbols with a preamble sequence for one frame cell interval;
a controller for controlling the peak detection of the second detection unit to be repeated a preset number of times for the plurality of frame cell intervals; and
a symbol selector for selecting as an frame cell start a symbol position repeatedly having a peak in the plurality of frame cell intervals.

6. The cell search apparatus of claim 5, wherein the second detection unit includes:
a preamble correlator for sorting the received OFDM symbols according to the acquired OFDM symbol synchronization and outputting correlations by correlating a frequency-domain signal of each OFDM symbol with the preamble sequence for the one frame cell interval; and
a maximum energy detector for detecting a maximum correlation among the correlations received from the preamble correlator in the frame cell interval, and outputting to the symbol selector the position of the symbol having the maximum correlation.

7. The cell search apparatus of claim 5, wherein if a plurality of symbol positions repeatedly have peaks in the plurality of frame cell intervals, the symbol selector selects as the frame cell start a symbol position having the highest correlation among the symbol positions.

8. The cell search apparatus of claim 1, wherein the pilot pattern detector includes:
a third detection unit for sorting the received frame cells according to the acquired frame cell synchronization and detecting a pilot pattern having a received energy equal to or greater than a threshold in one frame cell;
a controller for controlling the pilot pattern detection of the third detection unit to be repeated a preset number of times for the plurality of frame cell intervals; and
a selector for selecting a pilot pattern having the highest received energy or a pilot pattern detected at least a preset number of times and identifying the base station by the pilot pattern.

9. The cell search apparatus of claim 8, wherein the third detection unit includes:
a despreader for sorting the received frame cells according to the acquired frame cell synchronization and despreading a frequency-domain signal with spreading codes in one frame cell;
an energy calculator for calculating the received energy of each pilot pattern using despread signals received from the despreader; and
a comparator for comparing the received energy of the each pilot pattern with a threshold, detecting a pilot pattern having an energy greater than the threshold, and outputting the pilot pattern to the selector.

10. The cell search apparatus of claim 1, wherein the pilot pattern is a set of spreading codes used for pilots in a preset number of OFDM symbols forming a frame cell.

11. A cell search method in an orthogonal frequency division multiplexing (OFDM) mobile communication system, comprising the steps of:
acquiring OFDM symbol synchronization by performing cyclic prefix (CP) correlation for a plurality of OFDM symbol intervals;
sorting received OFDM symbols according to the acquired OFDM symbol synchronization, and acquiring frame cell synchronization by performing preamble correlation for a plurality of frame cell intervals; and
sorting received frame cells according to the acquired frame cell synchronization, and detecting a pilot pattern for identifying a base station by monitoring a plurality of frame cells.

12. The cell search method of claim 11, wherein the symbol synchronization acquisition step comprises the steps of:
detecting a peak by performing CP correlation on one OFDM symbol interval;
controlling the peak detection to be repeated a preset number of times for the plurality of OFDM symbols; and
selecting as an OFDM symbol start a sample position repeatedly having a peak in the plurality of OFDM symbol intervals.

13. The cell search method of claim 12, wherein the peak detection step comprises the steps of:
generating correlations by performing CP correlation for one OFDM symbol interval in a sliding window method; and
comparing the correlations with a threshold and detecting sample positions having correlations greater than the threshold.

14. The cell search method of claim 12, further comprising the step of, if a plurality of sample positions repeatedly have peaks in the plurality of OFDM symbol intervals, selecting as the OFDM symbol start a sample position having the highest correlation among the sample positions.

15. The cell search method of claim 11, wherein the frame cell synchronization acquisition step comprises the steps of:
sorting the received OFDM symbols according to the acquired OFDM symbol synchronization and detecting a peak by correlating frequency-domain signals of OFDM symbols with a preamble sequence for one frame cell interval;
controlling the peak detection be repeated a preset number of times for the plurality of frame cell intervals; and
selecting as an frame cell start a symbol position repeatedly having a peak in the plurality of frame cell intervals.

16. The cell search method of claim 15, wherein the peak detection step comprises the steps of:
sorting the received OFDM symbols according to the acquired OFDM symbol synchronization and generating correlations by correlating a frequency-domain signal of each OFDM symbol with the preamble sequence for the one frame cell interval; and
detecting a maximum correlation among the correlations and detecting a symbol position having the maximum correlation.

17. The cell search method of claim 15, further comprising the step of, if a plurality of symbol positions repeatedly have peaks in the plurality of frame cell intervals, selecting as the frame cell start a symbol position having the highest correlation among the symbol positions.

18. The cell search method of claim 11, wherein the pilot pattern detection step comprises the steps of:
sorting the received frame cells according to the acquired frame cell synchronization and detecting in one frame cell a pilot pattern having a received energy equal to or greater than a threshold;
controlling the pilot pattern detection to be repeated a preset number of times for the plurality of frame cell intervals; and
selecting a pilot pattern having the highest received energy or a pilot pattern detected a preset number of more times and identifying the base station by the pilot pattern.

19. The cell search method of claim 18, wherein the pilot pattern detection step comprises the steps of:
sorting the received frame cells according to the acquired frame cell synchronization and despreading a frequency-domain signal with spreading codes in one frame cell;
calculating the received energy of each pilot pattern using despread signals; and
comparing the received energy of the each pilot pattern with a threshold and detecting a pilot pattern having an energy greater than the threshold.

20. The cell search method of claim 11, wherein the pilot pattern is a set of spreading codes used for pilots in a preset number of OFDM symbols forming a frame cell.
